(19) United States
(12) Patent Application Publication
(10) Pub. No.: US 2020/0359859 A1
(43) Pub. Date: Nov. 19, 2020

(54) The Adjuster

(71) Applicant: Peter A. Loutos, Port St. Lucie, FL (US)

(72) Inventor: Peter A. Loutos, Port St. Lucie, FL (US)

(21) Appl. No.: 16/412,440

(22) Filed: May 15, 2019

(51) Int. Cl. A47K 17/02; A61G 7/02; A61G 7/10

(52) U.S. Cl. CPC A47K 17/028; A61G 7/1019; A61G 7/02

(57) ABSTRACT

This invention relates to a plumbing system, specifically a toilet system, and this invention is an advancement in the art and one model of a new category of toilets—namely pedestal toilets. This specific invention is an automatic model in the series of pedestal toilets which has been introduced to the world by the applicant. This automatic pedestal toilet comes equipped with pedestals which are encased in separate compartments in the base of the toilet. When defecation is in order, the user presses a button which activates the pedestals which are released alongside of the bowl so that the user can elevate the pedestals to one of five different height adjustments based upon the most efficient and comfortable placement for the user. The different levels will allow the user to place the pedestals at the precise point so that the spine is in the most efficient position to cleanse the bowels.

### BACKGROUND

### Field of the Invention

This invention relates to a plumbing system, specifically a toilet system, and this invention is an advancement in the art and one model of a new category of toilets—namely pedestal toilets. This specific invention is an automatic model in the series of pedestal toilets which has been introduced to the world by the applicant. This automatic pedestal toilet comes equipped with pedestals which are encased in separate compartments in the base of the toilet. When defecation is in order, the user presses a button which activates the pedestals which are released alongside of the bowl so that the user can elevate the pedestals to one of five different height adjustments based upon the most efficient and comfortable placement for the user. The different levels will allow the user to place the pedestals at the precise point so that the spine is in the most efficient position to cleanse the bowels. Historically this has been referred to as the “squatting” position. Heretofore, there has never been a toilet system designed with pedestals contained in the base of the toilet itself. Moreover, inherent in the design of this automatic model is the fact that the pedestals are part of the toilet itself and no additional device is required to be added by the user to achieve the “squatting” position. The five buttons for the different levels are conveniently located directly on the base of the stool. This particular invention only offers the ability to automatically adjust the pedestals to the desired level at the touch of a button. This will allow the user to achieve the “squatting” position which is perfect to align their spine for their needs and body type. Intentionally, the applicant limited the automatic feature to only the adjusting pedestals in this model to minimize the cost of production and ultimately the cost to the user.

### Description of the Related Art

The modern-day toilet most commonly used in the western world consists of multiple features to facilitate the user. There are multiple inventions that are already patented and are available in the market which either facilitate the user with an automatic flush system or automatic fragrance system for odor removal of noxious fumes, etc. In addition, there are numerous “smart” toilets which also offer “spa” features for the user.

There have been a large number of proposed automatic toilet flushing systems for use in various commercial and industrial establishments. As an example, automatic toilet flushing systems, which cause the automatic flushing operation of a toilet after a user leaves the immediate proximity of the toilet is frequently found in hotels, airports, train stations and like public use facilities.

The commercially available automatic toilet flushing systems generally operate on the principle of using a beam of radiation which can be interrupted to initiate a circuit operation and when the interruption, such as the person using the toilet system, removes themselves from the interrupting position, a control circuit causes a flushing operation.

A battery-operated automatic toilet flushing system has also been disclosed in U.S. Pat. No. 5,169,118 dated Dec. 8, 1992, entitled “Solenoid-Operated Battery-Powered Flush Valve”. In this particular system, the valve itself is actually powered by a battery and also uses infrared sensors connected to the battery along with a solenoid operable valve mechanism. However, the system taught in the '118 patent is again designed for commercial or industrial type toilet or urinal use. The present invention is applicable in all settings including residential, commercial, industrial, and all like public use facilities to promote better health.

Similarly, the flush toilet exhaust systems disclosed in the '856 and '590 patents are also designed to withdraw the odorous air from the airspace above the water level inside the water tank. These systems include a sealing means {'856 patent} or a flexible strip {'590 patent} that can be installed at the upper edge of the water tank. The sealing means of the '856 patent is a hollow strip being in air communication with a hose connector and a blower. The sealing means defines holes facing the interior of the water tank for receiving the odorous air from the airspace. After the odorous air enters the sealing means, it is pulled into the hose connector for remote exhaust. The flexible strip of the '590 patent seals the lid of the tank to create an airtight space from which the odorous air is withdrawn. Both systems require a vent device to reduce the problem of undesirable suction when the toilet is flushed.

Unlike the patents described earlier, the '544 patent describes a system that is designed to withdraw the odorous air from the upper end of the overflow pipe. This system includes a hollow, open bottom, vertical sleeve that is positioned over the upper end of the overflow pipe. The lower end of the sleeve terminates below the water level in the water tank so that a water seal is achieved to provide closed communication between the overflow passageway and the sleeve. The system also includes a means for creating low air pressure connected to the sleeve so that odorous air is drawn from the sleeve for remote exhaust. The inefficiency in withdrawing the odorous air from the sleeve into the exhaust pipe can be a drawback with this system, because only low air pressure can be applied so that the water within the sleeve is not also withdrawn. Yet another system disclosed in the '276 patent shows a toilet system that includes vent channels formed along the base and the back inside of the water tank. The system also includes a vent adapter mounted inside of the passage that directs the flow of ventilating air along the vent channels to an exhaust fan to the outside atmosphere. One drawback of this system is the requirement of a specially designed toilet bowl and water tank.

The present invention has been specially designed to provide automatic, elevating pedestals which are built directly into the base of a toilet, thus eliminating the need for a user to add any type of additional device currently found on the market to recreate the “squatting” position which aligns the spine to achieve the optimum position to cleanse the bowels most efficiently.

Similar to the ventilated toilet systems, several patents have disclosed different types of toilet systems that include automatic flushing mechanisms. For example, U.S. Pat. Nos. 4,831,670 and 5,369,816 disclose toilet systems having a weight-activated flushing mechanism. This type of mechanism includes an electric motor that is activated by the weight of the user sitting on and then leaving the seat. When the motor is activated, the tripping mechanism trips the flush valve open to allow the water to flush. A major drawback for the weight-activating flushing mechanism is that it does not operate when the user does not sit down on the seat. Therefore, when people who normally do not sit down on the seat for a urinal purpose use the toilet, the toilet will need to be flushed manually.

The present invention, through the use of the automatic, recessed, and encased pedestals improves the art by introducing a design for a toilet system where inherent in the design of the system and toilet are pedestals built directly into the base of the toilet. The applicant asserts that no search will disclose a patent which has been issued which has solved this problem prior to the introduction of this toilet system which actually creates a new category in toilet design and the applicant believes this new category will set the new standard for toilet design worldwide based upon the superior design which furthers the art and achieves greater health for the user. The new standard should be applied universally around the globe to increase the health of all humans.

A different flushing mechanism is disclosed in U.S. Pat. No. 5,901,384. This mechanism comprises a motion-sensing device positioned in the water tank and aligned with a window in the toilet cover when the cover is in a raised position. The motion-sensing device is operatively connected to a motor that drives an L-shaped lever that is connected to a flapper valve. The flushing system operates when the motion-sensing device is activated when the user uses the toilet and then moves away from the toilet. The motion-sensing device charges electric current to the motor which drives the lever upward such that the flapper is lifted to open the valve for the water to flush.

A similar flushing system is disclosed in U.S. Pat. No. 4,141,091. This system comprises three functional blocks: an input sensor or switch, a logic control circuit and an Electro-mechanically operated liquid dispenser or flusher. The whole assembly, which is attached to the inner side of the water tank, is hermetically sealed in order to protect the actuator against moisture and possible corrosion. The movable end of the plunger is with a chain or wire connected to the flush handle and drain valve. In the flushing system of '384 and '091 patents, most of the components have to be fitted inside the water tank. Possible concerns of these systems are in the limitation of fitting all parts into an existing toilet system and the need to modify the water tank and the toilet lid for positioning the motion-sensing device.

This invention would also serve a population of people who suffer temporary or permanent disabilities which may preclud{015} Heretofore, there has never been a toilet system designed with automatic, adjustable pedestals built directly into the base of the toilet. In addition, the pedestals are conveniently recessed into the rear of the toilet in separate cases, when defecation is necessary for the user the person simply touches a button to release the pedestals and then has the ability to adjust the height for the most efficient and comfortable position which recreates the “squatting” position. This is an automatic model in a new category of toilets—pedestal toilets—which will set the standard worldwide based upon the innovation of having the pedestals included with the toilet.

In many cases, governmental regulations now require the use of facilities which meet certain health standards. The U.S. Government Aid for Disabilities Act is an example of a required law which aims to assist the disabled population and this present invention would enable these people to much more easily and comfortably defecate efficiently for maximum health. A toilet operation that does not require engagement of a handle and is automatic with buttons conveniently placed directly on the toilet would be an attractive feature to comply with this Act.

Heretofore, there has never been a commercially available toilet system which has inherent in its design the inclusion of pedestals built directly into the base which are released automatically at the touch of a button. The five different levels which can be chosen by the user are controlled by buttons located directly on the base. Such an adaptation would be highly desirable for residential and commercial use.

It is to be noted that as per Applicant's knowledge, none of these prior art methods have been found to be completely suitable to meet these needs and are cumbersome and non-durable. Additionally, a thorough search of all is Hence, the inventor of the present invention proposes to resolve and surmount the existing technical difficulties and to eliminate the aforementioned shortcomings of prior art. Therefore, the object of the Adjuster model of the pedestal toilet system is to deliver an automatic toilet that comes equipped with pedestals that are released when needed for defecation and when not necessary they remain conveniently encased at the rear of the toilet.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

According to a first embodiment, the invention is a toilet system which creates a new category in toilet design and function—the pedestal toilet—whereby the toilet comes equipped with pedestals to raise the feet of the user during defecation and the pedestals are attached to the base as one unit.

According to a second embodiment, the present invention is a toilet system which has automatic pedestals designed into the base of the stool and are released at the touch of a button.

According to a third embodiment, the present invention is a toilet system which has elevating pedestals which offer five different levels for the user to achieve the “squatting” position.

According to a fourth embodiment, this invention offers pedestals which are built into the base and retract into the base when not needed by the user. This feature was designed into the present invention to make it easier for the user to access the toilet and offer a more streamlined and efficient toilet experience.

Therefore, it can be seen that the right combination of features incorporated in the device of the present invention produces surprising results that are not produced by the prior art. Moreover, a thorough search of all patentable toilet systems will disclose no prior art which has inherent in its design the feature of including retractable pedestals which are attached to the base as one unit. Additionally, an extensive market research will reveal no devices offered commercially on a worldwide basis, which offer the advantages of the present invention. In fact, the design of this present invention creates a new category and standard in toilet design. The Applicant believes the unique features of the present invention will be accepted universally as a crucial step forward in promoting worldwide health.

This summary is provided merely for the purposes of summarizing some example embodiments, so as to provide a basic understanding of some aspects of the subject matter described herein. Accordingly, it will be appreciated that the above-described features are merely examples and should not ne construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows the back view of the invention.

FIG. 2 shows the side view of the invention.

FIG. 3 shows top view of the invention.

FIG. 4 shows the complete prescriptive view of the invention.

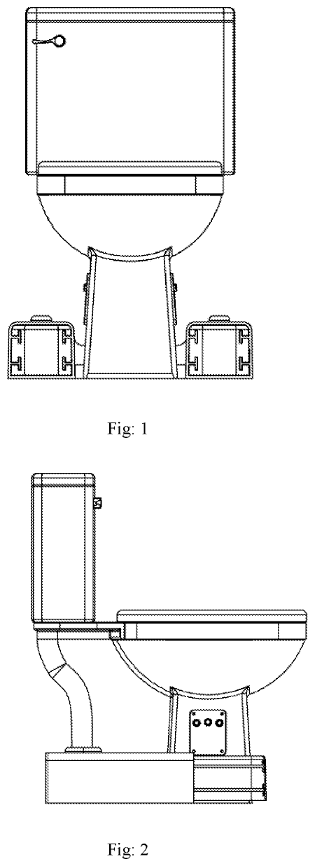

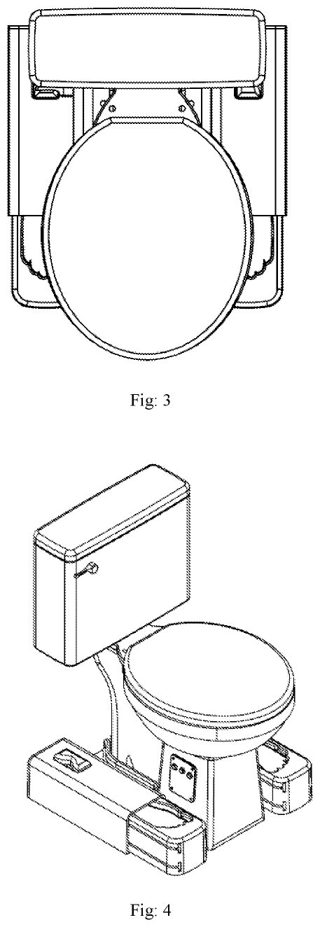

Skilled artisans will appreciate that elements in the figures are illustrated for simplicity and clarity and have not necessarily been drawn to scale. For example, the dimensions of some of the elements in the figures may be exaggerated relative to other elements to help to improve understanding of the embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

According to the Mayo Clinic, many people in the world don't have a safe way to use bathroom facilities around the world. Medical doctors, naturopaths, and assorted holistic health professionals have pointed out the hazards of the conventional toilets and their shortcomings. There is empirical evidence that conventional western toilet systems do not promote proper hygiene for the user. The present invention will allow the user to significantly increase the efficacy of a toilet by equipping and including automatic, elevating pedestals in the base of the toilet as standard equipment, thereby rendering obsolete the need to add any additional devices to the toilet to achieve the “squatting” position.

In any building, residential or commercial, the bathroom is certainly one of the most used and vital places in the property. Essential to human life is the efficient cleansing of the bowels to promote maximum health. The “squatting” position has been shown to be the most efficient position a human being can assume when defecating to thoroughly cleanse the bowels. The present invention, with automatic, elevating pedestals, solves a need which heretofore has not been addressed by any toilet system found anywhere in the world. No toilet system found commercially on the market and no patents issued for any toilet system include and involve the technology which is being introduced by this new category of toilets—pedestal toilets—and specifically this automatic model in the series.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that the various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

This invention relates to a plumbing system, but more specifically to a toilet system which offers a new category of toilets—pedestal toilets—which are toilets that come equipped with pedestals built directly into the base of the stool as one unit. As per Applicant's knowledge there has never been a toilet system designed which offers toilets that come equipped with pedestals to raise the feet of a user while defecation is in order.

Claim I: The present invention is an automatic model in the series and the user simply presses a button which activates the release of the pedestals alongside the base of the stool to raise the feet of the user.

Claim II: There are five levels which can be achieved by the user by simply pressing a button for the desired level to achieve the perfect “squatting” position for maximum efficiency and comfort for the user.

Claim III: The innovative feature of providing pedestals for the feet of the user which are built directly into the base and attached to the unit.
